(19) United States
(12) Patent Application Publication
(10) Pub. No.: US 2004/0193297 A1
(43) Pub. Date: Sep. 30, 2004

(54) Using a digital computer as a low power flashmedia player

(76) Inventors: Keith R. Mowery, Plano, TX (US); William F. Harris, Dallas, TX (US); Takeshi Sakai, Richardson, TX (US); Daniel G. Jensen, Plano, TX (US)

Correspondence Address: Dennis Moore, Texas Instruments Incorporated, M/S 3999, P.O. Box 655474, Dallas, TX, 75265, US

(21) Appl. No.: 10/400,213

(22) Filed: Mar. 27, 2003

(51) Int. Cl. G06F 17/00

(52) U.S. Cl. 700/94

(57) ABSTRACT

A computer apparatus (100) includes a low-power flashmedia access feature (102, 138, 142, 147). The computer apparatus can provide low-power flashmedia access without the use of: the normal display monitor (110); the CPU (120); and either the normal display monitor or the CPU.

### FIELD OF THE INVENTION

The invention relates generally to digital computers and, more particularly, to using a digital computer as a low power flashmedia player.

### BACKGROUND OF THE INVENTION

Portable computers (e.g., notebook, laptop, and palmtop) from major original equipment manufacturers, such as Toshiba, Compaq, Dell, and IBM, offer flashmedia dedicated sockets and flashmedia passive adapters as either standard or optional devices. Portable computers are aimed at the mobile computer user who takes work home from the office or on a business trip. The addition of flashmedia capability to portable computers enables the user to play a personalized collection of audio tracks.

The Windows operating system's media player, or third party audio application, can play back standard audio CDs and MP3 files on a portable computer. However, the simple function of playing integrated audio flashmedia requires that the entire portable computer system be powered for the duration of the audio play back. This causes excessive drain on the battery power system, consuming battery energy better saved for CPU intensive applications, such as word processing and spreadsheet analysis.

Conventional laptop and notebook computers typically have several power down modes. They can be powered down such that the CPU is almost completely off, with the state of the CPU saved on a hard drive. A very low power portion of the CPU or an auxiliary circuit (e.g. keyboard controller) is typically used to recognize when a key is pressed. The system then reactivates normal power to allow the CPU to retrieve the stored machine state from the hard drive, returning the computer to operating mode. Some well known power saving modes are sleep mode and suspend mode.

Consequently, a modern energy efficient portable computer will, over time, operate in several different power management modes. For example, if a portable computer is being used in an office environment where electrical power consumption is an insignificant concern, then the computer user may want the computer to provide the highest performance and availability possible. Conversely, if the computer is being operated on battery power where there is no convenient source of electrical energy, then the computer user may want to choose a power management mode for the computer that will maximize the time the computer operates without recharging its batteries, even at the expense of performance and availability.

To facilitate controlling electrical power consumption in personal computers, Intel Corporation, Microsoft Corporation, and Toshiba Corporation have jointly established an Advanced Configuration and Power Interface Specification (“ACPI Specification”). The ACPI Specification Revision 1.0 of Dec. 22, 1996, Copyright 1996 Intel Corporation, Microsoft Corporation, Toshiba Corporation, establishes a set of five (5) Global System States (G3: Mechanical Off, G2/S5: Soft Off, G1: Sleeping, G0: Working, S4: Non-Volatile Sleep) and a set of four (4) Device Power States (D0 through D3, Fully On to Off). The ACPI Specification defines the Global System States and Device Power States as follows:

G3: Electrical power is mechanically turned off.

G2/S5: Electrical power is turned on, but the computer consumes a minimal amount of power by not executing user and system computer programs. The system's context is not preserved by hardware.

G1: Electrical power is turned on. The system's context is preserved by hardware or system software, but user computer programs are not being executed.

G0: Electrical power is turned on and user computer programs are executed. In the G0 state, devices such as hard disk drives, flashmedia drives, and floppy diskette drives are dynamically turned on and off as needed.

S4: Electrical power may either be turned off (i.e., Global State G3) or turned on with the computer consuming a minimal amount of power (i.e., Global State G2/S5). The system context is preserved in a non-volatile storage file before the computer enters either the G3 or G2/S5 state, thereby permitting the computer to be restored to its prior operating state (i.e., G1 or G0). D0: The device is completely active and responsive, consuming the most electrical power.

D1: A lower power state than D0. D1 is defined for different types of devices and preserves more device context than the yet lower power state, D2.

D2: An even lower power state than D1. D2 is further defined for different types of devices and preserves less device context than D1.

D3: Electrical power is fully removed from the device. Device context is lost and system software must reinitialize the device when it is turned on again.

The different computer operating modes and associated power management regimes described above are each characterized by a unique power demand (e.g., current drain) from the battery power supply. This is an important feature both in design of portable computer systems, and in marketing them as well. A great deal of attention has been focused on minimizing the power demand for each of the different Global and Device operating modes. Thus, the power demand characterizing each power management regime is a critical factor to be considered for portable computers, particularly one that includes a cardbus controller with flashmedia capabilities that can play MP3 files.

In implementing conventional computer power management strategies, a power management routine (“PMR”) executed by the CPU must periodically monitor peripheral devices to assess whether a peripheral device's operation may be suspended. Similarly, if it becomes necessary to access a peripheral device whose operation has been suspended such as in Device Power modes D1-D3, the PMR must resume that peripheral device's operation. Generally, suspending the operation of a peripheral device and resuming its operation respectively require that the PMR executed by the CPU perform a unique sequence of operations in turning off electrical power to a peripheral device, and in turning electrical power back on. Writing a computer program that detects a need to execute a power-on or a power-off sequence of operations for a peripheral device is a cumbersome task.

Previous portable computers that include flashmedia adapters use PMR functions to minimize battery drain. However, if CPU operation has been suspended to save electrical power, the computer can essentially do nothing. Therefore, in the minimal power drain mode, the CPU cannot use the Windows operating system's media player or third party audio application to play audio MP3 files.

A significant percentage (approximately 60-70%) of the power drain in portable computers is caused by display monitor (e.g., LCD monitor) use. Therefore, even if a computer's devices, including the CPU, were in a lower power state (e.g., D1-D3) during flashmedia only play, the need to use the monitor to display flashmedia and/or track status would itself impede significant power consumption reduction.

For the reasons described above, it is apparent that a disadvantage of present portable computers for playing audio MP3 files is that some portion of the computer system must remain in an energized state to detect key actuation and then to restore power or activate a power restore function of the CPU and associated peripherals (e.g. hard drive, keyboard controller, display, etc.). When a portable computer is being used during travel, or when line power is otherwise unavailable, the user may wish to play some audio files. Given the limited battery life of most portables (e.g., 3 to 5 hours of use), the user may not be able to use the flashmedia capability for very long, out of fear that the portable will not be functional for needed work or communication.

It is therefore desirable to provide a solution that enables a computer user to use flashmedia while reducing the drain on the power source. Various exemplary embodiments of the present invention can provide this by allowing the user to access flashmedia without the use of: (1) the normal display monitor; (2) the CPU; and (3) either (1) or (2).

### BRIEF DESCRIPTION OF THE DRAWINGS

The above and further advantages of the invention may be better understood by referring to the following description in conjunction with the accompanying drawings in which corresponding numerals in the different figures refer to the corresponding parts, in which:

FIG. 1 diagrammatically illustrates exemplary embodiments of a digital computer in accordance with the present invention;

FIG. 2 diagrammatically illustrates exemplary states and state transitions of a digital computer audio subsystem in accordance with the present invention;

FIG. 3 diagrammatically illustrates exemplary operations of a digital computer audio subsystem in accordance with the present invention; and

FIG. 4 diagrammatically illustrates exemplary operations of a digital computer in accordance with the present invention.

### DETAILED DESCRIPTION

While the making and using of various embodiments of the present invention are discussed herein in terms of portable computers and MP3 files, it should be appreciated that the present invention provides many inventive concepts that can be embodied in a wide variety of contexts. The specific embodiments discussed herein are merely illustrative of specific ways to make and use the invention, and are not meant to limit the scope of the invention.

The present invention provides a solution that enables a computer user to use flashmedia while reducing the drain on the power source. Exemplary embodiments of the present invention can provide this by allowing the user to access flashmedia without the use of a display monitor.

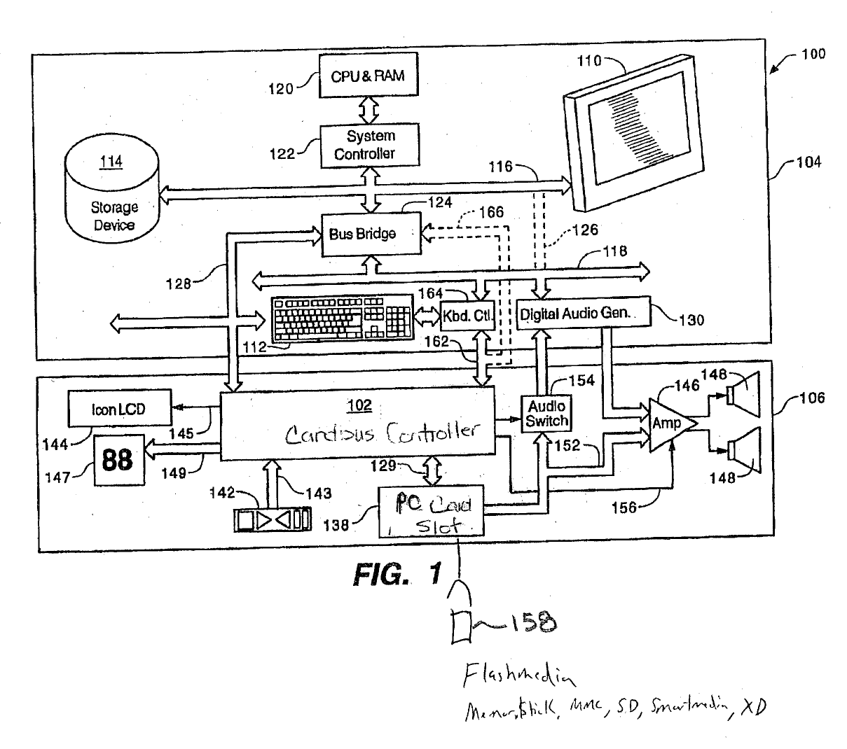

FIG. 1 diagrammatically illustrates exemplary embodiments of a digital computer 100 in accordance with the present invention, wherein digital computer 100 is illustrated as functionally separated into subsystem 104 and subsystem 106. Subsystem 104 includes conventional data-processing components, such as central processing unit (“CPU”) and random access memory (“RAM”) 120 which can communicate with system controller 122. System controller 122 can communicate with the remainder of the components of subsystem 104 through a bus, such as bus 116 illustrated as further communicating with display monitor 110, storage device 114, and bus bridge 124. Bus bridge 124 interconnects busses 116, 118, and 128. In the exemplary embodiment illustrated in FIG. 1, bus 128 can communicate with subsystem 106. In some exemplary embodiments, as indicated by dashed lines 166, bus bridge 124 may communicate directly with bus 162, which can communicate with keyboard controller (“KBD CTL”) 164 and subsystem 106. KBD CTL 164 can connect manual input devices, such as device 112, to bus 118 or, in some exemplary embodiments, as illustrated by dashed lines 166, to bus bridge 124. CPU & RAM 120 can communicate with digital audio generator 130 through the combination of bus 116, bus bridge 124 and bus 118. In some exemplary embodiments, as indicated by dashed lines 126, CPU & RAM 120 can communicate with digital audio generator 130 through bus 116.

In accordance with exemplary embodiments of the present invention, subsystem 106 can include Cardbus controller 102, PC card slot 138 (e.g., a PCMCIA card slot), control buttons 142, icon liquid crystal display (“LCD”) 144, track-number display 147, audio output amplifier 146, and audio output transducers 148 (e.g. speakers or headphones). Control buttons 142, which can connect to Cardbus controller 102 via control-button bus 143, can include buttons for controlling the play of MP3 files on flashmedia 158 when flashmedia 158 is placed in PC card slot 138. Conventional PC card slot 138 can be capable of operating with conventional ATA interface commands that can originate at Cardbus controller 102 and be provided through bus extension 129. Subsystem 106 can also include bus 152 that can supply left and right channel stereo audio signals directly to audio output amplifier 146 from PC card slot 138. Loudness control-signal line 156 can couple a volume control signal from Cardbus controller 102 to audio output amplifier 146. Depending upon the operating mode of the computer 100, audio switch 154, which can operate in response to control signals received from Cardbus controller 102, may couple the left and right channel stereo audio signals to digital audio generator 130. In order to reduce electrical power consumption caused by electrical leakage currents in elements included in subsystem 104 when not energized, audio switch 154 can electrically isolate bus 152 from PC card slot 138 and Cardbus controller 102 can electrically isolate itself from bus 128.

Both subsystem 104 and 106 can receive electrical power directly from a battery(not shown). Depending upon the operating mode of computer 100 for playing MP3 files, either the subsystem 106 alone, or both subsystem 104 and 106 may be energized. If subsystem 104 receives no electrical power, then operation of PC card slot 138 is performed completely within subsystem 106 as Cardbus controller 102 can originate signals for controlling operation of PC card slot 138. If subsystem 104 is energized and operating, then operation of PC card slot 138 can be controlled, via Cardbus controller 102, in response to commands received from a computer program executed by CPU & RAM 120. Commands and data used to control operation of PC card slot 138 are conventionally known.

In some embodiments, an audio-interface IC in the cardbus controller is coupled to the digital computer bus of the computer subsystem, to the flashmedia socket (138), and to the flashmedia control buttons. The audio-interface IC, in a first operating mode in which the computer subsystem is energized and operating, relays commands and data between the digital computer bus of the computer subsystem and the flashmedia socket. In a second operating mode in which the computer subsystem is not energized and is inoperative, the audio-interface IC autonomously responds to signals received from the flashmedia control buttons and transmits commands to the flashmedia socket which cause the flashmedia cardbus controller to play an audio file present in the flashmedia socket.

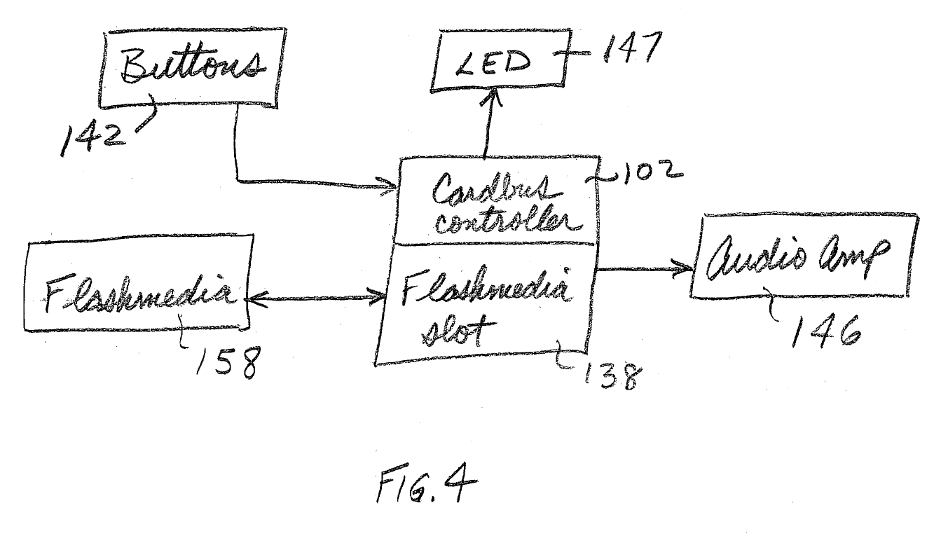

FIG. 4 diagrammatically illustrates exemplary operations of a digital computer in accordance with the present invention. Flashmedia 158, when inserted in PC card slot 138 (see also FIG. 1), can either be read from or written to using conventionally known decoding and coding methods. Buttons 142 can control which MP3 files on flashmedia 158 are accessed for play. LED 147 can display information related to the MP3 file currently being accessed (e.g., current file being played, time from beginning of file access, and time remaining until end of file access). An MP3 file selected by buttons 142 from flashmedia 158 inserted in PC card slot 138 can be decoded and then sent to audio amp 146.

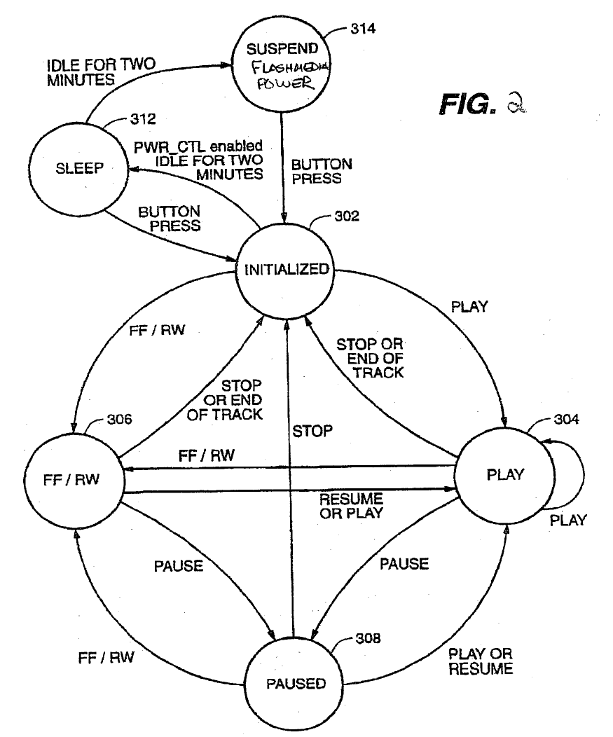

In some exemplary embodiments, if subsystem 104 is energized and operating, Cardbus controller 102 can transparently relay commands and data between bus 128 and PC card slot 138. FIG. 2 depicts exemplary states and state transitions of Cardbus controller 102 for an operating mode of computer 100 in which subsystem 104 is not energized and is inoperative. When subsystem 104 is not energized and subsystem 106 is initially energized, or immediately after Cardbus controller 102 is reset, Cardbus controller 102 can enter an initialize state 302, shown in FIG. 2.

In some exemplary embodiments, pressing a play/pause button when Cardbus controller 102 is in initialize state 302 can cause Cardbus controller 102 to transition to play state 304 in which Cardbus controller 102 can transmit commands in accordance with the ATA protocol to PC card slot 138, energizing subsystem 106 to play MP3 files. If Cardbus controller 102 is in play state 304, then pressing a stop or eject button, or reaching the end of all the MP3 files, can cause Cardbus controller 102 to re-enter initialize state 302 and to return to the first of the MP3 files.

In some exemplary embodiments, while Cardbus controller 102 is in play state 304, pressing either a fast-forward (FF) or a rewind button (RW) can cause Cardbus controller 102 to enter fast-forward-or-rewind state 306. In fast-forward-or-rewind state 306, Cardbus controller 102 can transmit commands to PC card slot 138 that either fast-forward or rewind the MP3 files. If PC card slot 138 completes a fast-forward or rewind command, or reaches the end or beginning of an MP3 file, Cardbus controller 102 can re-enter initialize state 302. While subsystem 106 is fast-forwarding or rewinding an MP3 file, pressing a play button can cause Cardbus controller 102 to enter play state 304 and resume playing the MP3 files at the beginning of the present file.

In some exemplary embodiments, while Cardbus controller 102 is in play state 304 or in fast-forward-or-rewind state 306, pressing a pause button can cause Cardbus controller 102 to enter pause state 308 which pauses operation of PC card slot 138. If Cardbus controller 102 is in pause state 308, pressing a play button can cause Cardbus controller 102 to enter play state 304 and resume playing the MP3 files at the present location in the file, pressing either a fast-forward or rewind button can cause Cardbus controller 102 to enter state 306, and pressing a stop button can cause Cardbus controller 102 to enter initialize state 302.

In some exemplary embodiments, if Cardbus controller 102 is in initialize state 302, and a signal has been supplied to Cardbus controller 102 enabling the supply of electrical power to PC card slot 138 and/or audio output amplifier 146 and a pre-established interval (e.g., two minutes) passes during which none of control buttons 142 are pressed, then Cardbus controller 102 can enter sleep state 312. Upon entering sleep state 312, Cardbus controller 102 can send an ATA protocol sleep command to PC card slot 138, thereby slowing down a clock associated with PC card slot 138. If Cardbus controller 102 is in sleep state 312 and a second, pre-established interval (e.g., two minutes) passes during which none of control buttons 142 are pressed, then Cardbus controller 102 can enter suspend state 314 in which Cardbus controller 102 can transmit a signal to indicate that the PC card slot 138 has not been operating recently. Electrical circuitry included in subsystem 106 may use this signal from Cardbus controller 102 for removing electrical power from both PC card slot 138 and audio output amplifier 146. If Cardbus controller 102 is either in sleep state 312 or in suspend state 314, then pressing any of control buttons 142 can cause Cardbus controller 102 to re-enter initialize state 302.

Additionally, in some exemplary embodiments, when subsystem 104 is energized and operating, Cardbus controller 102 can receive commands from control buttons 142 and can store such commands for subsequent retrieval by a computer program executed by CPU & RAM 120. In this operating mode the computer subsystem is energized and operating, and the audio-interface IC receives commands from the flashmedia control buttons and stores such commands for subsequent retrieval by a computer program executed by the CPU. Furthermore, in this operating mode, as directed by a computer program executed by the CPU, the audio-interface IC either merely relays commands and data between the computer subsystems's digital computer bus and the flashmedia drive, or independently responds to flashmedia button commands by generating flashmedia commands internally, and independently transmitting such commands to the flashmedia adapter or dedicated socket to control playing an audio file present in the flashmedia adapter or dedicated socket.

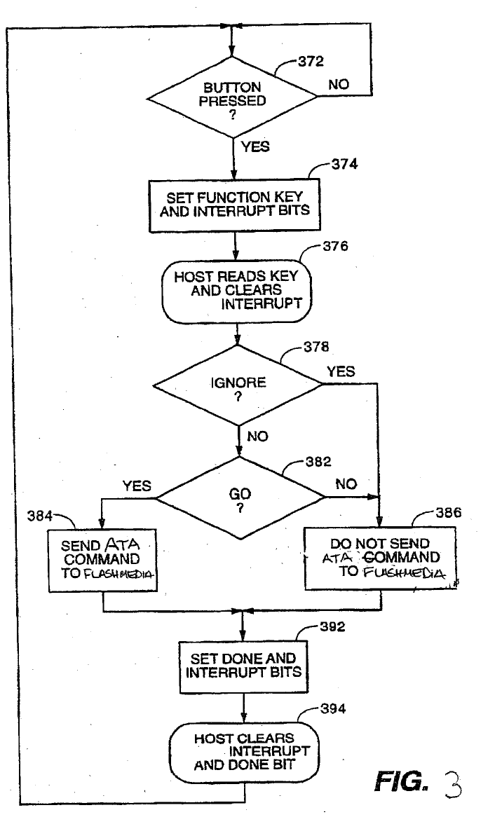

FIG. 3 diagrammatically illustrates exemplary operations of a digital computer audio subsystem in accordance with the present invention when subsystem 104 is energized and operating. As illustrated in FIG. 3, while a user does not press any of control buttons 142, operations can loop at decision block 372 waiting for one of control buttons 142 to be pressed. If any of control buttons 142 are pressed, processing in block 374 can set function keys and interrupt bits. A computer program executed by CPU & RAM 120 can respond in block 376 to the settings made in block 374 by reading the function key settings and clearing the interrupt bits. After block 376, a decision can be made in blocks 378 and/or 382 that can determine whether or not to send ATA commands to the flashmedia, in blocks 384 and 386, respectively. Decisions can be made based on key and bit settings as known in the art.

After performing either block 384 or block 386 processing, the done and interrupt bits are set in block 392. As before, a computer program executed by CPU & RAM 120 can respond in block 394 to the settings made in block 392 by clearing the interrupt and done bits. After block 394, operations can return to block 372 to resume waiting for one of control buttons 142 to be pressed.

It will be evident to workers in the art that the exemplary embodiments described above can be readily implemented by suitable modifications in software, hardware or a combination of software and hardware in conventional computers such as desktops, notebooks, laptops, and palmtops.

Although exemplary embodiments of the present invention have been described in detail, it will be understood by those skilled in the art that various modifications can be made therein without departing from the spirit and scope of the invention as set forth in the appended claims.

What is claimed is:

1. A computer apparatus, comprising:
a central processing unit for performing data processing operations selected by a user;
an input interface coupled to said central processing unit for permitting a user to input information to said central processing unit;
a display coupled to said central processing unit for permitting said central processing unit to output information in visual format to a user;
a flashmedia connector for connection to a flashmedia device; and
a controller coupled to said flashmedia connector and operable independently of said central processing unit for controlling access to a flashmedia device when the flashmedia device is connected to said flashmedia connector.

2. The apparatus of claim 1, wherein the flashmedia device includes audio information.

3. The apparatus of claim 1, wherein the flashmedia device includes MP3 information.

4. The apparatus of claim 1, wherein said controller includes a state machine.

5. The apparatus of claim 1, provided as a portable computer apparatus.

6. The apparatus of claim 5, provided as one of a desktop computer, a notebook computer and a laptop computer.

7. The apparatus of claim 1, wherein said central processing unit is coupled to said flashmedia connector for controlling access to a flashmedia device when the flashmedia device is connected to said flashmedia connector.

8. The apparatus of claim 7, wherein said controller is connected between said central processing unit and said flashmedia connector.

9. The apparatus of claim 1, wherein said controller is for controlling access to the flashmedia device via ATA commands.

10. The apparatus of claim 1, including a man/machine interface coupled to said controller for permitting communication between a user and a flashmedia device when the flashmedia device is connected to said flashmedia connector.

11. The apparatus of claim 10, wherein said man/machine interface includes an input interface.

12. The apparatus of claim 11, wherein said man/machine interface includes a visual output interface.

13. The apparatus of claim 12, wherein said visual output interface includes one of a liquid crystal display and a light emitting diode display.

14. The apparatus of claim 13, wherein said input interface includes a pushable button.

15. The apparatus of claim 12, wherein said input interface includes a pushable button.

16. A computer apparatus, comprising:
a central processing unit for performing data processing operations selected by a user;
an input interface coupled to said central processing unit for permitting a user to input information to said central processing unit;
a display coupled to said central processing unit for permitting said central processing unit to output information in visual format to a user;
a flashmedia connector for connection to a flashmedia device; and
a man/machine interface coupled to said flashmedia connector and operable independently of said input interface and said display for permitting communication between a user and a flashmedia device when the flashmedia device is connected to said flashmedia connector.

17. The apparatus of claim 16, wherein said man/machine interface includes an input interface.

18. The apparatus of claim 17, wherein said man/machine interface includes a visual output interface.

19. The apparatus of claim 18, wherein said visual output interface includes one of a liquid crystal display and a light emitting diode display.

20. The apparatus of claim 19, wherein said input interface includes a pushable button.

21. The apparatus of claim 18, wherein said input interface includes a pushable button.
